(19) United States
(12) Patent Application Publication
(10) Pub. No.: US 2026/0077484 A1
(43) Pub. Date: Mar. 19, 2026

(54) Control Processes and System for Hybrid Autonomous Robots

(71) Applicant: Sarcos Corp., Salt Lake City, UT (US)

(72) Inventors: Denis GARAGIC, Salt Lake City, UT (US); Fraser M. SMITH, Salt Lake City, UT (US); Marc X. OLIVIER, Salt Lake City, UT (US); Daniel HAGEN, Salt Lake City, UT (US); Samuel CHESEBROUGH, Salt Lake City, UT (US); Eric MCCLAIN, Sandy, UT (US); James TIGUE, Sandy, UT (US)

(21) Appl. No.: 18/886,664

(22) Filed: Sep. 16, 2024

Related U.S. Application Data
(60) Provisional application No. 63/586,402, filed on Sep. 28, 2023.

(51) Int. Cl. B25J 9/16; B25J 9/00; B62D 57/032

(52) U.S. Cl. CPC B25J 9/1605; B25J 9/0009; B25J 9/163; B25J 9/1661; B25J 9/1674; B62D 57/032

(57) ABSTRACT

Technology is described for a controller or control service that facilitates the use of robots as hybrid machines. More specifically, a task space controller can be provided for an robot with hybrid input from either a human or programmed tasks.

### PRIORITY CLAIM

This application claims priority to U.S. Provisional Patent Application Ser. No. 63/586,402 entitled “Control Processes and Framework for Hybrid Autonomous Robots” which was filed on Sep. 28, 2023.

### GOVERNMENT LICENSE RIGHTS

This invention was made with government support under Contract No. FA8649-20-C-0175 awarded by the Air Force Research Laboratory. The government has certain rights in the invention.

### BACKGROUND

Robotic systems are becoming more robust and powerful. A wide variety of robots are becoming more prevalent in practical uses as the technologies and efficiencies improve. Previous industrial applications have employed robots with limited mobility. Consequently, assuming that the robot is firmly attached to the ground, interaction control (e.g., manipulation) is usually achieved separately from whole-body posture control (e.g., balancing). However, some robots may provide users with the ability to occupy a robotic exoskeleton, robotic vehicle and/or humanoid robots, etc., with augmented autonomy and physical mobility to accomplish tasks.

### BRIEF DESCRIPTION OF THE DRAWINGS

FIG. 1 illustrates an example of an exoskeleton-human robot being used by a human or executing autonomously.

FIG. 2 is a block diagram illustrating an example of services and components of a controller service.

FIG. 3 is a contextual space block diagram illustrating an example environment and control layers for the robot.

FIG. 4 is a block diagram illustrating an example of services and functions that may be contained within a robot level control layer of FIG. 3.

FIG. 5 is a block diagram illustrating an example configuration of the mid-level controller that receives user input and translates the input into robot states.

FIG. 6 is an image illustrating an example of a human operator (right) that uses a motion capture system to control a virtual robot in a simulation (left).

FIGS. 7 and 8 illustrate examples of exoskeletons being used with human input.

FIG. 9 illustrates an example of a human providing distant input to the robot.

FIG. 10 illustrates an example of a robot that may include auto-balance capabilities and the ability to semi-autonomously lift weights (e.g., bags with weight).

FIG. 11 illustrates an example of a robot lifting weights while being guided by a distant human user.

FIG. 12 illustrates a virtual model of a hybrid exoskeleton robot from two perspectives.

FIG. 13 an example use of the controller with a simulated robot in a lifting application with a simulated environment for development purposes.

FIG. 14 illustrates a user controlling a robot in a simulated environment to generate task specific data.

FIG. 15 (left) illustrates an example of a controller system being trained to scan a pipe using the simulation tool and then (right) scanning a pipe using a robot.

FIG. 16 is a flowchart illustrating a method for controlling a robot with hybrid control.

FIG. 17 illustrates equations 1 through 17.

FIG. 18 illustrates equations 18 through 27.

FIG. 19 illustrates equations 28 through 34.

FIG. 20 illustrates equations 35 through 37.

FIG. 21 illustrates equations 39 through 45.

FIG. 22 illustrates equations 46a through 49.

FIG. 23 is a block diagram that provides an example illustration of a computing device that may be employed in the present technology.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

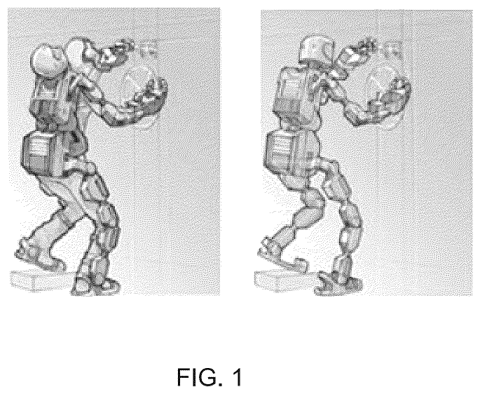

This technology relates to a controller or control service that facilitates the use of robots as hybrid machines. For example, a task space controller can be provided for a robot (e.g., an exoskeleton-humanoid floating-base robot) with hybrid input from either a human or programmed tasks. FIG. 1 illustrates an example of an exoskeleton-human robot device being used by a human or executing autonomously.

The controller or control service may be used with a wide variety of robots. The types of robots that may be used with the controller may include exoskeleton-humanoid types of robots, humanoid type robots, fixed base robots, vehicle robots, semi-autonomous vehicle robots, disaster response robots, construction robots, industrial robots, consumer robots, delivery robots, articulated robots, service robots, military and security robots, telepresence robots, medical robots, autonomous robots, drones, aerospace robots, aquatic robots, delta robots, cobots, gantry robots, space robots, agricultural robots, construction robots, or other types of robots.

In one example, the controller or control service can manage a fully powered robot as a versatile hybrid machine. This machine can effectively serve dual roles, operating either as an operator-driven robot or as an autonomous robot. An example machine may be a humanoid robot or full body exoskeleton that is roughly the height of a user or operator and may have actuated joints that are designed to operate around the user, coinciding with the user's corresponding joint centers of rotation. When a user is not present, this example robot may have enough degrees of actuation to fully control its position and orientation without user input. In that way, the technology enables the machine to operate either with or without an operator.

Users may have the ability to occupy a robot (e.g., a robotic exoskeleton, humanoid robot, or vehicle) with augmented autonomy and physical mobility to accomplish tasks. Within this context, physical interactions between a human user and the robot (where applicable) and the robot and environment influence the stability, balance or control of the robot and/or the user in the robot. The robot controlled by the controller may be an exoskeleton robot, a humanoid robot, a portion of a humanoid form, a humanoid torso, at least one humanoid arm, humanoid legs, a humanoid hand, an end effector or a vehicle such as: a crawler, a tractor, an automobile, a truck, a tank, an airplane, a ship, mining and earthmoving equipment, backhoes, bulldozers, excavators, material handlers, pavers, construction equipment, farming equipment, industrial equipment, a flying drone, or other robots that may be controlled by a user. Alternatively, the robot may operate autonomously under direction of the controller.

To allow a robot to overcome barriers between interaction and posture control, the principles of whole-body coordination with contact dynamics may be used to achieve physical autonomy for the robot (e.g., exoskeleton or mobile vehicle), improved safety of operations, and dexterity of locomotion and manipulation tasks. Achieving physical autonomy for the robot (e.g., exoskeleton) may use free-floating robot control (as opposed to conventional fixed-base control). Free-floating mechanical systems tend to be underactuated and generally cannot be fully feedback linearized. The problem becomes even more complex when these systems are constrained. In one example, an exoskeleton is a legged robot, and its dynamics are subject to a set of time varying, non-linear constraints imposed by the robot itself (e.g., rigid, unilateral contacts with the ground constrains the foot motion) and compliance constraints between a human operator and the robot (e.g., operator experience, size, weight).

In one example configuration, a controller (e.g., control framework) can be used with a robot (e.g., a full-body exoskeleton or a mobile vehicle) to provide a hybrid autonomous robot that may use a unified torque-level control methodology that may prioritize desired tasks to achieve advanced compliant manipulation and maneuvering behaviors under the physical constraints imposed by human environments. Whole-body kinematic and dynamic models may be used, which exploit the dexterity of the robot, and in the example of an exoskeleton, may account for the underactuated modes to create high-end skills. The processes and systems may include guidance of the low-level joint-torque controllers by prioritized task-space inverse dynamics control with the explicit estimation of contact forces and joint torques used to execute tasks.

This technology and controller (e.g., control framework) may be used with robots that do not have human kinematics and where the scaling of the robot may not be humanoid in size (e.g., robots that are larger or smaller than human sizes). In fact, most robots currently being used or produced do not possess human kinematics. The controller may also be used with non-anthropomorphic configurations by using models that map human kinematics to the robot kinematics and/or result in controlling an endpoint/gripper in an intuitive manner (sometimes also referred to as “Task Space Control”). For example, a user may use their hand to control a robot endpoint and then a computer may capture where the person's hand is located, then position the robot's endpoint in the same relative position and orientation as the person's hand. The kinematic computations and use of joints for accomplishing that endpoint positioning may be invisible to the user. Accordingly, the controller may control robots that are not kinematically equivalent or similar to humans and may not be intuitive to operate. However, such robots can perform the desired tasks where the robot is capable of carrying out a desired collection of motions. In particular, these robots may be non-humanoid and non-exoskeleton configurations.

The controller may be used with any type of robot where the scaling is different than human scaling and may be used with robots that may or may not have human kinematics (most robots do not have human kinematics). The robots can also be scaled completely differently than human kinematics. For example, an N:1 scaling may be used where N represents the size scaling or an inter-joint distance scaling of a robot as compared to human metrics. The scaling can even be different from one joint to the next.

There may be at least two types of scaling that may be different than humanoid types of robots, including: 1) the scaling of the size of the overall robot as compared to a human (e.g., a very large or small robot compared to a human) and 2) the scaling of the inter-joint distances between the joints as compared to a human. As an example of scaling, a user might want to train a robot backhoe to carry out a given operation. Not only are the kinematics different from a person but so are the scalings between joints (i.e., some links are longer and others are shorter as compared to a human). Some joints in a human may not correspond at all to the joints in a robot. So, the scaling may take these factors into account. In a further robot backhoe example, the controller for the robot backhoe may be configured to map the bucket as being equivalent to the hand. The controller for the robot backhoe may have the bucket arm and vehicle perform the motions to position the bucket like a hand of a user is relatively positioned and oriented. Any type of non-humanoid robot may be controlled by a human using this controller, even if the scaling is not consistent with a person or humanoid form. For instance, the robot might be mechanically robust (but not humanoid in form) or be able to accomplish certain kinds of tasks optimally.

Many robots are not scaled to exactly match human physiology but still may be controlled by the controller of this technology. For example, humans may have joints that intersect at a shoulder, one bend joint and three joints that intersect at the wrist for a human's arms. A robot that the controller may manage might not have all of these joints. In some humanoid robots, the joints may be located at the same points as in the human body but other humanoid robots may not correspond directly. Some humanoid robots do not have all the degrees of freedom (DOF) but they are still a humanoid form factor and they have human kinematics. Any type of humanoid robot or partially humanoid robot can be controlled by the controller.

The controller may manage robots that have a distance between the joints that is a human scaling, robots that have non-human scalings for joints, and robots that are non-scaled robots. In scaling, the robot may not be the same size as the person but the scaling may have inter-joint distances that have a human ratio. For example, in a large robot arm, the kinematics may be same as a person but the overall scaling of the arm and inter-joint distances may be N times (e.g., 2 to 10 times) a person's arm sizing. When a user is mastering the device, then a scaled robot with human ratios does things more intuitively because the joints are where a human expects them to be.

Most robots that exist are not similar to a human physiology. Not only are the kinematics different but such robots might use joints or rotations that are not human in form or the distances between joints are not human either. The present controller may control any type of non-humanoid or humanoid form factor regardless of whether or not the robot is intuitive to control.

In the past, systems have been described to control articulated free-floating rigid bodies through exploitation of an operational-space framework. More recent approaches have explored the idea of simplifying the system dynamic equations by performing suitable projections onto the null space of the contact forces. While being computationally efficient (i.e., a total computation time below 1 millisecond), these previous approaches share a common drawback: contact forces cannot be controlled. As a consequence, the stability of the contacts for a robot cannot be guaranteed, which may lead the robot to tip over and fall.

As an alternative to these analytical solutions to the control problem, a numerical approach using a solver can be used by this technology. The solver may be at least one of: a quadratic solver, a hierarchical quadratic solver, a genetic learning solver, a reinforcement learning solver, ant colony optimization, simulated annealing solver or a machine learning solver. This allows inclusion of inequality constraints into the problem formulation, which can model control tasks and physical constraints (e.g., joint limits, motor torque bounds, force friction cones, payload variations). However, solving a cascade of programs or programming models (e.g., quadratic programming models) with inequality constraints can be inefficient from a computational standpoint. This technology is a hybrid approach that may allow control of the contact forces (thus guaranteeing balance and locomotion) and mapping of operator intentions and state inputs to desired device state outputs with a computational complexity of the same order as inverse-dynamics-based methods.

### Physics-Based Modeling

One example modeling approach may use a physics-based dynamic model of floating base robots. The control approach used in this technology is applicable to any robotic system. CAD-based drawings may be used to provide the kinematic and mass properties necessary to build physics-based rigid body models used by an intelligent control system that include kinematics and dynamics, actuation dynamics (e.g., harmonic drive, revolute joint, linear actuation), human dynamics, sensing models (e.g., EO/IR cameras, LIDAR, acoustic, IMUs, force sensors), interaction forces/moments between the robot and its environment. Importantly, these models may incorporate (a) underactuated degrees of freedom and multi-contact constraints, (b) whole-body kinematic and dynamic models of the tasks' objectives, and (c) mechanical models of the internal forces and moments taking place between contact closed loops.

Such models can enable the construction of compliant torque controllers for whole-body force and motion interactions under geometrical and contact constraints, thus supporting high-fidelity simulations validated with experimental data. A physics-based modeling approach may utilize virtual simulation environments to develop the capability to accurately and efficiently simulate populations of robotic devices (e.g., exoskeletons, vehicles, fixed base robots, etc.) operating in complex indoor and outdoor environments. The simulation approach and evaluation methods in virtual environments provide an affordable and reliable framework for experimenting with different sensing and acting mechanisms to verify the performance functionality of robots in dynamic scenarios. This approach makes it possible to rapidly test processes, design useful robot kinematics and dynamics, perform regression testing, and train AI system using realistic scenarios, without risking any physical resources.

The technology has a hierarchical controls framework that integrates AI/ML/Optimization in order to control a robotic device (e.g., floating-base robots). This framework may transform a robotic system into a versatile hybrid robot. This hybrid robot can be operated with an operator inside the robot (e.g., as an exoskeleton robot or vehicle) or the hybrid robot may operate autonomously (e.g., as a humanoid robot).

The control service or controller significantly enhances the dexterity, mobility, safety, and autonomy of the robot. For example, this technology is adaptable for use with hybrid powered exoskeleton devices or systems.

In one example, a controller can be used on a robot (e.g., a floating base system) using hierarchical quadratic programming to explicitly control the centroidal momentum of the robot. Controlling the centroidal momentum may prioritize safety, operator intent (if present), and task space goals (e.g. balance, motion) in that order, while satisfying dynamic constraints. The control service may generate computed torque control commands to achieve desired robot behavior, either with or without the presence of an operator.

In one embodiment, the controller may collect the current robot state and user input and the task prioritization manager may prioritize tasks for the solver (e.g., hierarchal quadratic program solver). The solutions computed may result in physical output (e.g., instructions and electrical control signals) for the robot. In an alternative embodiment, the solver may not prioritize task but may have pre-set task orderings or a limited number of tasks.

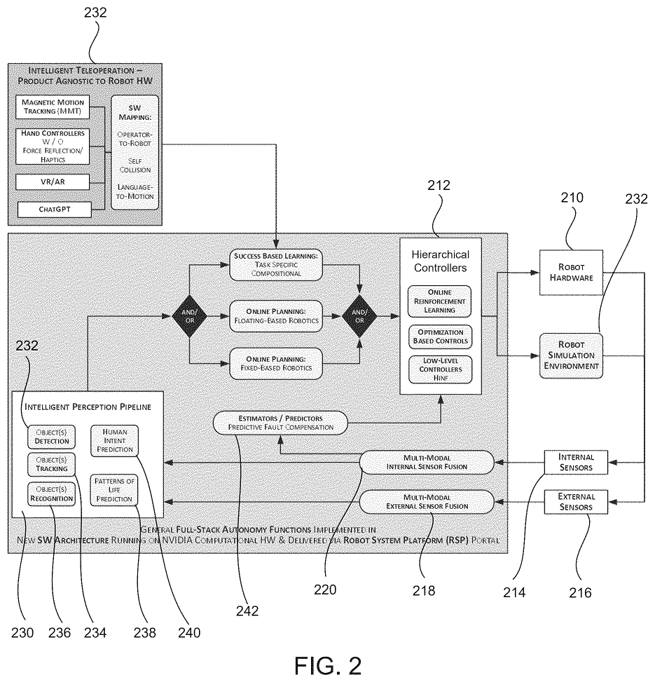

A block diagram illustrating high level components of the control services are illustrated in FIG. 2. A robot or robotic device may be robot hardware 210 that is able to host a user inside (e.g., an exoskeleton or a vehicle). The robot may have internal sensors 214 to sense user input from a user embedded in the robot and external sensors 216 to sense external environment states and characteristics. Accordingly, an initial operation may be recognition in data from the robot hardware. Any type or form of robotic hardware 210 may be used, as discussed earlier, including hardware with magnetic motion tracking, hand controllers, robots with AR/VR interfaces, AI interfaces, etc.

The information from the internal sensors 214 and external sensors 216 may be combined together for analysis in the internal sensor fusion 220 and external sensor fusion 218 services. For example, sensor data may be collected to enable analysis of all of the contact information from the feet and from user inputs. The dynamic state of the robot may be the estimation of these states from internal and/or external sensors. The sensors may collect information from direct sensing forces or indirectly detecting forces (e.g., perceiving through multiple joints what the payload is).

Collecting this data helps estimate the state that is trying to be achieved for the whole system. These estimated input forces are used to execute the tasks in hierarchical controller(s) 212 with a prioritized stack. For example, the system may limit an amount of force coming to the feet to avoid moving the foot off the ground. This may include estimating the ground reaction force to keep the robot's weight up and moving properly, and taking into account the user input. This array of information may be included in a solution for staying balanced and/or moving loads.

The controller may also use logic and artificial intelligence (AI) to determine what should be done next. This is illustrated by the intelligent perception pipeline 230. The determination of what to do may include submitting data to artificial intelligence (AI) processes that may provide: object detection 232, object tracking 234, object recognition 236, patterns of life prediction 238, self-collision avoidance, estimators and predictors 242, human intent prediction 240 and other predictive services.

Data collection may be used to measure whether the system or controller is tracking the task correctly and whether the right forces are being output correctly. One goal is to minimize the error between the desired task and measured output/task. The error difference can be measured and modifications can be made to the output instructions to the robot to reduce the error difference or delta between the desired task and the measured output/task. This results in a closed loop controller that is actively correcting for errors in order to complete the desired tasks. In an example, a robot may have a task that is desired to be completed. All the state inputs from the robot can be collected. Then the progress to that goal can be measured by minimizing the error between the desired task and measured output of the robot.

The hierarchical controller 212 may receive user input from inside a robot, or the hierarchical controller 212 may control a robot as an autonomous robot when no user input is being received. For example, the hierarchical controller 212 may manage and compute the momentum. The hierarchical controller 212 may also prioritize the tasks being processed by the controller or the hierarchical controller 212 may receive the tasks with priorities and process the tasks in priority order. Some tasks may be identifying and processing any constraints. Other tasks may be controlling the momentum of the robot, interpreting the robot's states as received from sensors, interpreting an environmental state based on information received from external sensors, and processing user input estimates. These inputs and tasks go into a prioritization stack and the data is used for solving for robot joint torques. Furthermore, the hierarchical controller(s) 212 may be used to solve the hierarchy optimization model. For example, one of the main tasks is the control of momentum. The hierarchical quadratic program in the hierarchical controller(s) 212 can use a denotation of what the specific priorities are during the solving process. Specific sub-services of the hierarchical controller 212 may be user or provide reinforcement learning, optimization based controls, or low level controllers HINF (health information about the robot).

The prioritization of tasks may be set in a number of ways. The priorities of tasks may be set by: a developer, an administrator, an application, physical constraints, time, space, etc. In one example, the highest priority task processed by the hierarchical controller may be safe completion of the tasks undertaken by the robot. Accordingly, the system may sacrifice performance for safety. Completion of physical tasks with or without human input may be set to a lower priority than safety. In another example, the priorities might prioritize limits on acceleration and motion in a scientific space application. The control of speed may be another item that is prioritized. Task prioritization may also be driven by whether the robot can complete the task when desired along with taking the appropriate safety measures and constraints to protect humans or the local surroundings.

In some example applications, balance may be important but staying within a certain speed envelope may not be as important. One specific example may be a fire rescue task and then the leg of the robot may be allowed to kick down doors. In this case, the priority is to get the job complete at all costs (with the exception of injuring the user or operator). Similarly, if there is a bystander, the safety task for the hierarchal controller might be programmed to avoid the bystander and protect other people.

Forbidden zones may be set for safety purposes and they may also receive a high priority when being processed by the hierarchal controller stack. As an example, if the robot enters a bubble or set of boundaries where the robot might hit the operator or a person, the hierarchal controller may prioritize reduced movement or no movement over obeying motion instructions but those restrictions may only apply in the forbidden zone. In a war situation, the hierarchal controller may be directed to prioritize reaching a target over increased safety measures.

The prioritization is also useful because those tasks with higher assigned priorities may get preference in processing. For example, the controller may first satisfy dynamic constraints, then safety constraints, and finally task constraints in descending priority. In another example variation, the user input may be set at a higher priority than the tasks or keep out zones. In addition, dynamic constraints tend to be a high priority, followed by balancing of the robot, and then the physical tasks to be performed may be a lower priority.

One of the main tasks to be solved is working to keep the robot upright, whether there is a person in the robot or not. Another important task is predicting where the person is going to move to provide power to that portion of the robot. The intelligent hierarchal controller 212 can be used to solve a balance task, task manipulation, a walking task, avoidance of self-collision, a safety task, a human input task, a communication delay task, a motion task, a lifting task, a placement task, a reorientation task, an adjustment task, a manipulation task, etc. The intelligent hierarchal controller 212 will first process whatever task has a top priority in the prioritized stack of tasks with or without user input.

The user may have access to interface points in the robot. The interface points for the robots are locations where motion and force from the user are measured. The data from the sensors can be used to sense human intent through motion and/or force from the user. For example, a humanoid type robot may have six interaction points in: the torso, the pelvis, one on each hand and one on each foot of the robot. As mentioned earlier, the sensor data may be processed by artificial intelligence to determine a user's intent. This hierarchical controller can control any type of robot regardless of its form. For example, the hierarchical controller may apply to a partial humanoid form, a crawler, a quadruped form, a vehicle, automobile, trucks, tractors, tanks, airplanes, ships, etc.

Utilizing the sensor information in a coherent way may allow the robot to move (e.g., walk) and lift up objects. The robot does not require human inputs to do the same tasks the robot can do with the human inputs, and the robot may perform the same task with or without user input.

Many types of sensors can be used in the robot(s). In one example, the robot can get user input from motion capture, and the motion capture may be used to train the robots. The hierarchical controller can be executing and take into account the task perception that is going on for the human, and then the hierarchical controller computes the needed outputs to the robot.

This same hierarchical controller processing can be used to provide both robot control without user input or to obtain user input information to provide robot behaviors. In the past, robots (e.g., exoskeletons) have not generally been used in a hybrid fashion in a single robot. However, this technology can incorporate the human input into the stack of tasks being resolved and computed using prioritization. User input may be from force torque sensors, motion capture, or force feedback and the robot can be controlled in part by a human inside the robot or a human distantly controlling the robot.

In another example, a humanoid robot (e.g., an exoskeleton) or a vehicle can operate autonomously in one configuration. In this example case, the controller can autonomously take over the tasks, including balance or driving tasks, when a human is not inside the robot or when a human is controlling the robot from a distance. For example, an exoskeleton or robotic vehicle can be a cooperative robot that can be autonomous or guided by a human. When a user is inside the robot, then the robot is guided by the user. Otherwise, the robot can perform a programmed task without the user or without using distant guidance. When the robot does not receive human input, the robot can switch over to its own programmed tasks at the set priority level of the tasks and perform the tasks. Examples of tasks that a robot can perform with or without human input can be: moving loads, balancing, imitative learning, reinforcement learning, etc. A robot can perform any physical task as long as the robot can reach the needed location or lift the relevant object. These physical tasks may include: polishing, wiping, cutting, lifting up to 100 lbf in a stable fashion, moving objects and other physical tasks.

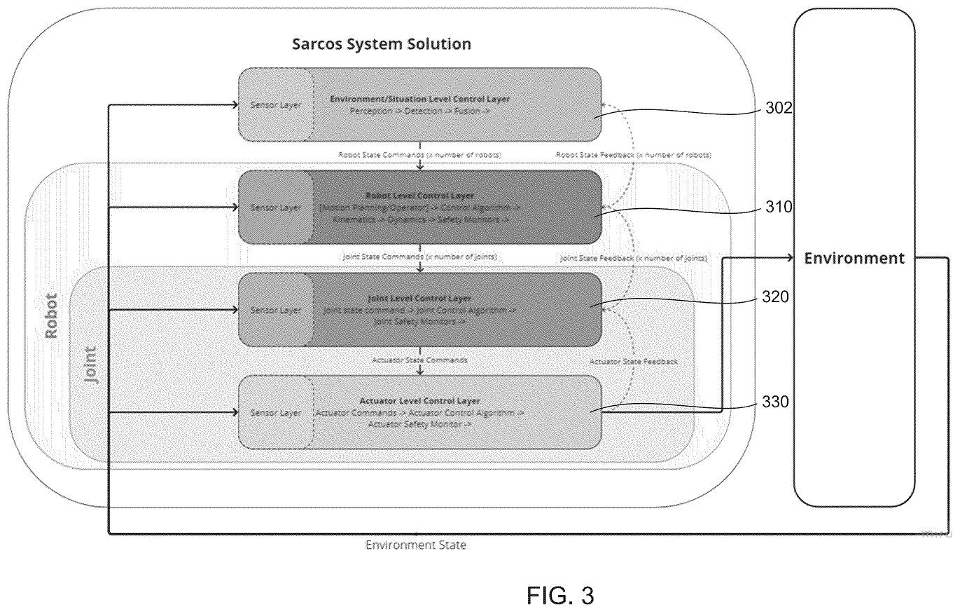

FIG. 3 is a contextual space block diagram illustrating an environment and situation control layer 302 which may obtain inputs from sensors regarding the robot and environment state. This may be building a perception of the world or model of the world for the robot. The robot state for the individual robot may also be obtained along with a robot state command (or desired robot state from an autonomous task or user input). This information may then be fused together to create an overall robot and environment state.

The hierarchical controller may be in the robot control layer 310 and may process the tasks as described elsewhere in this description. Another layer is the joint command layer 320. Joint state commands may be sent to joints such as: a rotary joint, wheels, articulation in an arm, thrusters for underwater robot, perception devices (meta data to send to get action). There may be many joints on a robot. This process fuses information from the incoming layers, then sends out joint state commands. The safety monitors may be processed by the controller or other services at every layer in this process.

Another layer is the actuator layer 330. Many actuators may exist per joint. For example, two linear actuators may be used to create a rotary joint. This is the output that affects the robot and the environment. For example, in an exoskeleton, electric current may be sent through the motors and may create torque at the joint that interacts with the environment.

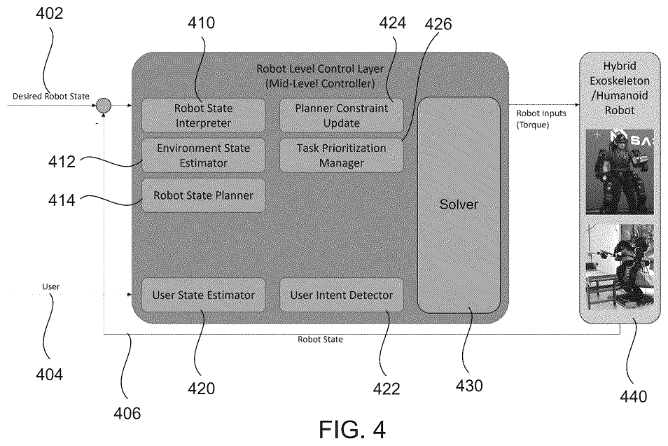

FIG. 4 is a block diagram illustrating services and functions that may be contained within a robot level control layer. Robot state inputs 406, including internal sensor data and external sensor data, may be received along with a desired state of the robot 402. The robot state interpreter 410 can interpret the meaning of the internal sensor data in terms of the robot state. An environment state estimator 412 can also process the external sensor data to create a representation of the environment. User inputs 404 may be received in a user state estimator 420 that identify a user state. A user intent detector 422 can receive the detected user state and predict the user's intent.

The robot state planner 414 can be used to plan the next robot state using the robot state, environment state, user input, constraints and/or the desired task. The planner constraint update service 424 may provide constraints, such as safety constraints. The task prioritization manager 426 can also be used to prioritize tasks that are sent to the solver 430 (e.g., a hierarchical quadratic solver). The results or instructions from the solver 430 may be sent to the hybrid robot 440 (e.g., a hybrid exoskeleton or hybrid humanoid robot).

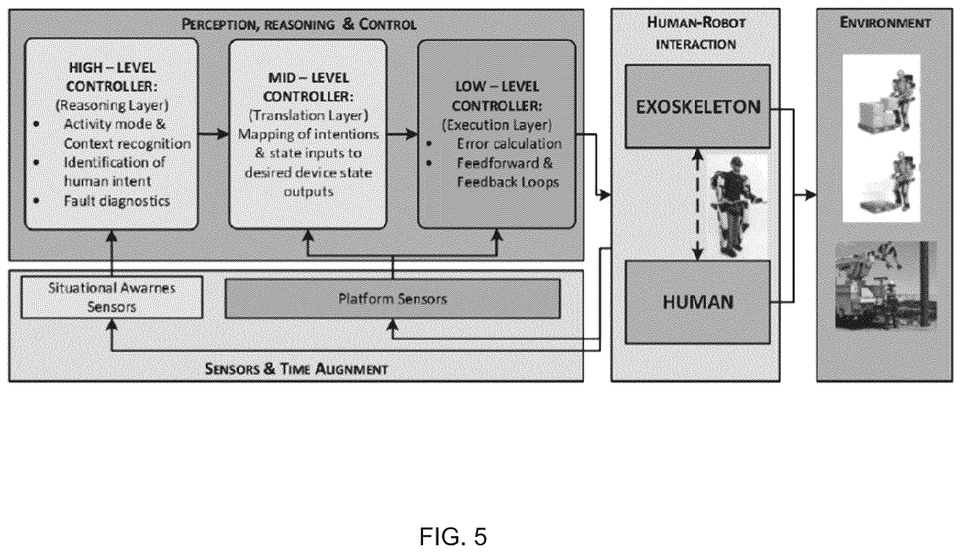

FIG. 5 is a block diagram illustrating another example of the mid-level controller in the overall system that receives user input and translates the input into robot states. More specifically, the hierarchical controller may receive user input and estimate the user's intent at the high level and then translate the user's intent into device states at the mid-level. Finally, these commands may be executed in the low level by the robot hardware. Environmental awareness may be achieved by observing and reasoning over the user inputs (via interoceptive robot sensors) and environmental inputs (via exteroceptive situational awareness sensors).

One application a robot (e.g., a hybrid exoskeleton) is deployment in environments too perilous for human users or operators, such as those containing smoke, chemical exhaust, extreme cold or extreme heat. In such situations, the user can exit the robot, enabling the robot to function autonomously (e.g., as a humanoid robot or vehicle). This eliminates the necessity of human exposure to harm. In general, such a control service extends the operational envelope of what a robot (e.g., an exoskeleton) can do to include a wide array of autonomous tasks. These tasks can include, but are not limited to, lifting and walking in either structured or unstructured environments. Another example task is moving a box from a shipping pallet to a conveyor belt. The user can perform this function inside the robot (e.g., an exoskeleton or transport robot), or the same hybrid machine can autonomously perform the action (e.g., acting as a humanoid robot). A further example is if the user decides to step out of the robot (e.g., exoskeleton), the hybrid robot can sustain its balancing task in the presence of disturbances created by the operator climbing out. This provides a dynamic way for an operator to don/doff a robot (e.g., an exoskeleton) without the need for explicit hardware or hookups dedicated to stabilizing the robot during this process.

### Model-Based Design Approach

A model-based design approach for embedded control and AI development may be used for robots. This approach may improve product quality and reduce development and implementation time by at least 50% due to code auto-generation. This iterative design cycle (repeated for each capability) may follow a number of stages.

One stage may be the design and simulate stage. The system model may include every component that affects system behavior, including: processes, control logic and physical components. This system model may also capture customer, end-user, and developer requirements in an executable specification. Simulation allows analysis of system performance in conditions otherwise too expensive, risky, or time-consuming to investigate in the physical world.

Implementation may be the next stage. The system model may automatically generate source code (e.g., C, C++, or HDL code) for rapid prototyping or production. Generated code may be optimized and combined with hand-written code as necessary.

A further stage may be to integrate, verify, and validate. This third step may test and verify that the system model meets requirements as the outcome. This step may also include integration onto the robotic host devices and verification and validation of correct device behavior with the new software load to achieve readiness for the assessment step. This step may provide a reusable test harness for virtual integration and hardware-in-the-loop testing. In addition, this step may analyze models, requirements, and tests to assess design quality and compliance with standards such as ISO 12100. The assessment step may perform the user utility assessment exercises or tests.

In one example, the physics-based modeling approach utilizes virtual simulation environments to develop the capability to accurately and efficiently simulate populations of robotic devices operating in complex indoor and outdoor environments. The simulation approach and evaluation methods in virtual environments can provide an affordable and reliable framework for experimenting with different sensing and acting mechanisms to verify the performance functionality of the robots in dynamic scenarios. This approach makes it possible to rapidly test methods, design optimal robot kinematics and dynamics, perform regression testing, and train AI systems using realistic scenarios without manufacturing physical resources. One major impact of this virtual environment approach is that the virtual approach affords low cost and/or low risk experimentation with task changes and refinements. This permits exploration of user expectations that become possible when intelligent robotic colleagues and/or robotically-enhanced operators (occupants or teleoperators) provide such feedback. Another important impact is that this environment enables hardware-in-the-loop simulation to rapidly evaluate control strategies and perception and autonomy methods. This virtual environment approach also increases exploration speed and flexibility when working to achieve device enhancements, produce new devices, and improve development efficiency.

### Human Interaction Approach

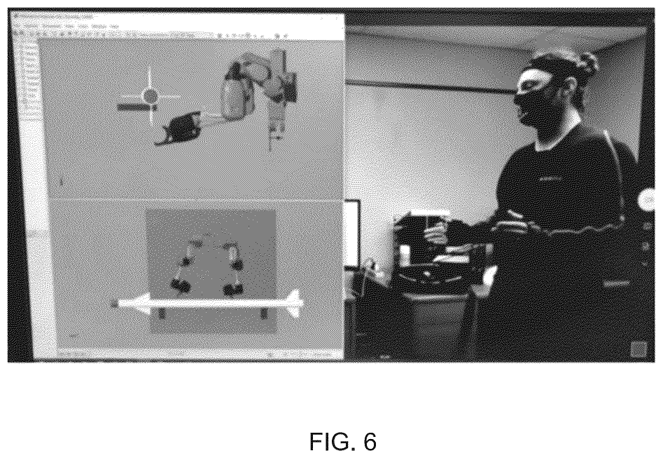

This technology may allow the mapping of human body motion (e.g., arm motion) to simulate and/or perform actual robotic system movements (e.g., robot arm and end-effector movements.) This easily and intuitively provides user control of simulated robotic devices because free body movements create control inputs that use robotic effector degree of freedom redundancy and anthropomorphic characteristics to produce human-like trajectories on the virtual robot arm. Applying this control method, a user can execute various locomotion and manipulation trajectories without the need to program kinematic motion for such tasks. FIG. 6 illustrates this thrust interaction between a human operator and the robotic device manipulator model inside a virtual environment using a motion capture system.

This interaction provides a teleoperated control approach for an anthropomorphic redundant robotic manipulator, using magneto-inertial sensors. Task performance using this approach may result in the capture of trajectories in (simulated) robot joint space that may be used to execute the operational space end effector trajectories. Such inputs to may be used teleoperate both simulated and physical devices to execute tasks remotely.

One advantage of this technology over prior existing technology is the ability to improve the safety of the robot by providing the functionality for the robot to assess its own safety and stability metrics and take actions to improve the safety and stability. The safety limits can be included in the stack of tasks to be processed. Tasks can be added, removed or changed for the controller and the tasks may include dynamic constraints to prevent a fault from occurring. The safety checks can include determining: whether communications are occurring in a timely manner, whether there is too much torque, whether the robot is moving too fast, whether the robot is upside down, etc. When there is an unsafe condition, then the controller can flag that something is wrong.

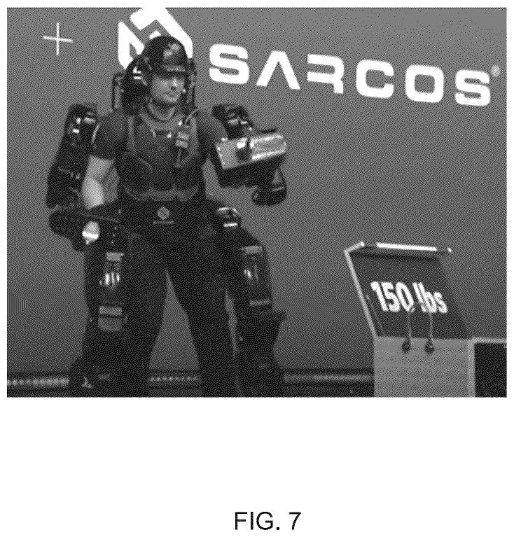

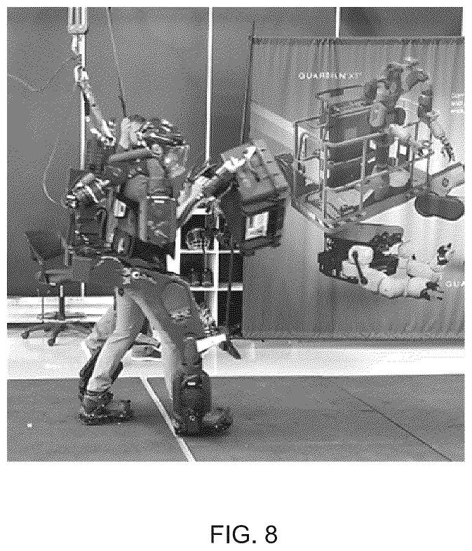

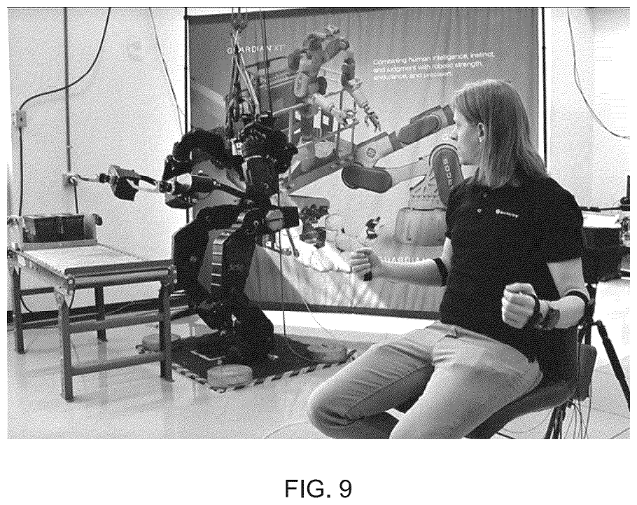

As discussed earlier, tasks may be performed without an operator, which can improve safety and/or productivity for the robot. An example use of the control service is in a full-body exoskeleton being used to lift heavy payloads (up to 150 lbf) and walk at speeds up to 3 mph. The robot may operate in several locations or environments, both on-tether and off-tether. A full-body exoskeleton has been used in several pilot use-case studies across several industries and defense sectors for numerous users of disparate shapes and sizes. FIGS. 7-8 illustrate examples of robots being used by a human who is providing human input. FIG. 9 illustrates an example of a human providing distant input to the robot.

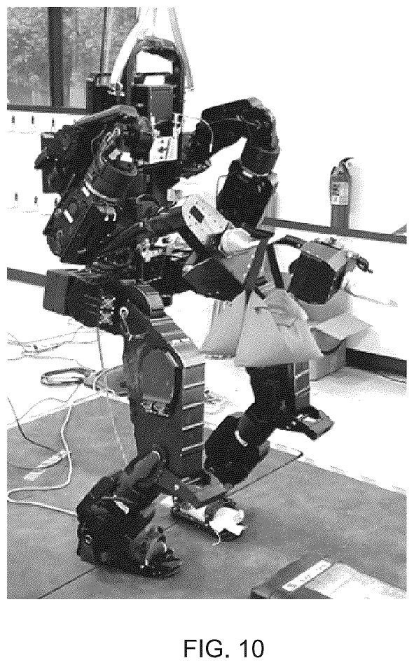

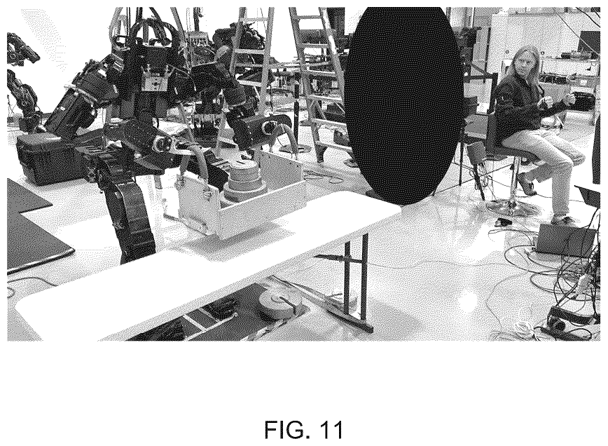

In addition, an example of the robot usage (e.g., a hybrid exoskeleton/humanoid robot) may include auto-balance capabilities and/or the ability to semi-autonomously lift up to 100 lbf using the hierarchical controller (e.g., for managing tasks, space, and momentum) to balance the robot while the end-effectors were made to mimic a human teleoperator to lift weights, as illustrated in FIG. 10. The hierarchical controller may dynamically minimize a payload felt by an operator while lifting and carrying different payloads. FIG. 11 illustrates a robot lifting weights while being guided by a distant human user.

In the example of lifting payloads, there may be distinctions between different portions of the task. The ability for a user or operator to sense a load may be important at high resolution when the user is interacting with a load or an object that is being lifted from a resting state to a lifted state. However, the ability of a user to sense a load may become inconsequential when the load is being moved. One goal of the task may be to avoid making the user tired and the load may be removed or lightened while the load is moved. The requested task or service can determine whether canceling weight out is important or not. There may be potions of the task where the force fidelity matters and other portions of the task where force fidelity does not matter. The user may also to desire to feel the moment when the user puts the weight on a shelf or in a hole. Using the desired force fidelity allows the user to feel when the user contacts the shelf and at what angle. Feeling the forces may help the user perform the task. Then in the transit of the weight, the robot can remove the load completely.

Tasks may have portions of the task that have modified forces based on the goals of a task. In other words, there may be a dynamic aspect of forces that may felt by the user or applied by the robot over time or during time steps in completion of a task. The portions of a task with modified forces may be portions of tasks such as portions of lifting, pushing, pulling, grabbing, using a tool, carrying weapons, etc. During specific segments of the task, the user may want to feel a portion of the forces to reinforce what the user is doing and a portion of what forces the user is exerting. Then in other portions of the tasks, the forces may be modified. In one example, the robot can have thresholds set and the system can compare to a threshold over time for each time step to see if forces felt by a user should be increased or decreased using the robot.

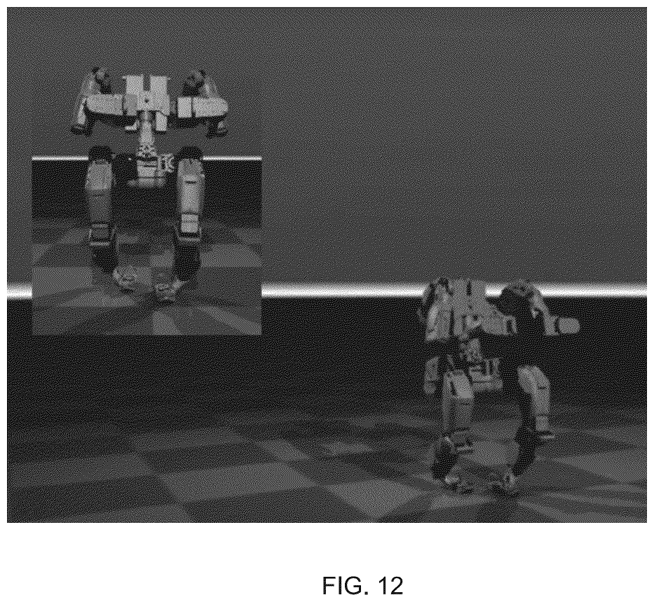

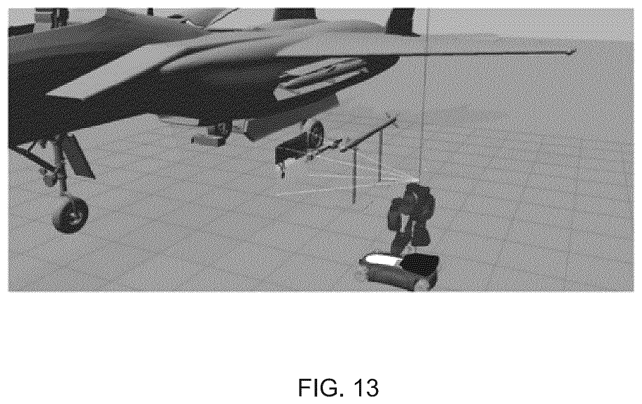

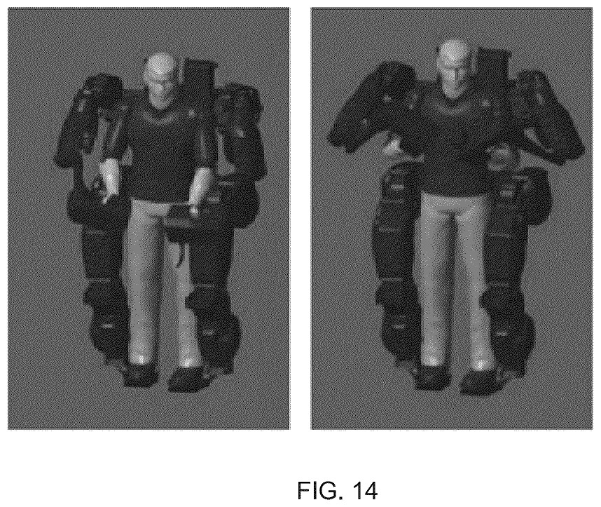

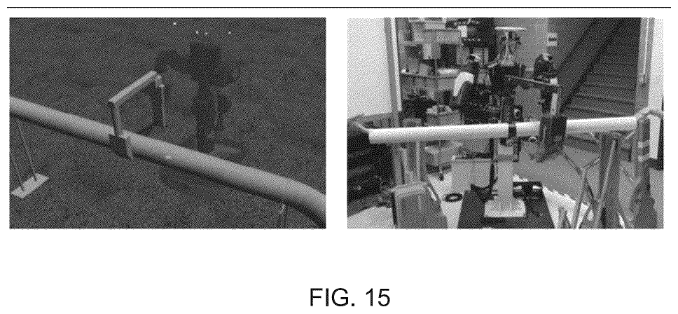

FIG. 12 illustrates a virtual model of a hybrid exoskeleton robot from two perspectives. FIG. 13 illustrates the use of the controller with a simulated robotic device in a lifting application that is simulated for development purposes. The simulated use case may involve munitions loading (e.g., AIM-9 Sidewinder) on 4th generation aircraft (e.g., F-15 and F-16 aircraft) to highlight the capabilities of the robot. Use case simulation development may include modeling details of task-relevant objects (e.g., aircraft and munition) and operational spaces. The simulated workspace provides a configurable and modular prototype environment system that is readily adaptive to several operational spaces. The end result is a proof-of-concept that completely simulates the robot and sensing systems in a virtual aircraft hangar with human-guided operation of robotic devices. FIG. 13 specifically illustrates a robot operating in a virtual scene of the munition loading use case. FIG. 14 illustrates a virtual user or operator controlling a robot in a simulated environment to generate task specific data. FIG. 15 (left) illustrates an example of a controller system being virtually trained to scan a pipe using the simulation tool and then (right) scanning a pipe using a real robot.

Another useful aspect of this virtualized human interaction approach is that it provides natural, realistic, and safe, training opportunities for task novices. This form of interaction with virtual devices allows untrained individuals to get used to performing a task safely while out of harm's way. This means that a user can also be trained to operate the robot using the virtual model of the robot. Another impact is the increased opportunities afforded by low cost/low risk experimentation. A further result is that the virtual modeling provides opportunities to assess safety hazards to the user in cases of falling and/or stumbling while operating the robot and how to mitigate such situations with improvements in robot controls and mechanical design.

The operations for a task for an autonomous robot can also be developed and tested using the simulation of the robot and environment. As a result, a task that has been developed to be performed autonomously or with user input can be tested using the virtual model in the simulated environment to determine whether the task is programmed properly. Furthermore, a task can be tested using the virtual model in the simulated environment to determine that the robot is physically able to perform the task.

The boundaries of operations in a task or boundaries of the overall task may also be developed using a simulation environment. Specifically, repeated sets of user input may be collected for a single task in order to define an expected range of task operations and/or user inputs or robot outputs for the task. A range for task operations may be an envelope or boundary defined by an aggregate grouping of recorded user input for the same task. This means a data set may be developed that quantifies the variation that is possible for a task. When a user completes a given task numerous times, then recordings of those operations may be used to establish an expected range of operations for a task versus operations in the task that might qualify as an error condition.

In one configuration, reconfigurable feedback for the controller may include dynamic constraints to account for the probability of a fault occurring as predicted by a fault detection and diagnosis (FDD) process sent to the solver (e.g., hierarchical quadratic solver) or quadratic programming optimizer. The FDD may include artificial intelligence (AI) to check whether faults are occurring and models may be trained to support AI detection of faults.

The FDD can process error detection using data from internal or external sensors of the robot. Thus, the system can recognize patterns of behavior that lead to fault states. The task for FDD may be in communication with the hierarchical controller and/or the quadratic programming optimizer. An FDD task may be designed to prevent faulting and may have a priority that is higher than other tasks. For example, if a fault is detected, the hierarchical controller can stop a load lifting task to avoid the shut down or identify conditions that may lead to a fault before the fault occurs. Alternatively, the FDD task can report to user when a fault is detected but before a corrective action is undertaken.

The robot and controller may be used with a teleoperation framework to allow an operator partial control of the robot from a distance. The hierarchical controller can be used with teleoperation of a modeled system providing control of a task and enabling dynamically consistent control of systems both with or without large time delays. Changes may be made to a virtual model of the robot to facilitate direct control of a modeled robot or indirect control of a real robot both with and without time delays by using syncing of changes to the real system.

The controller may also be used in tele-operations situations and to take into account delays in such tele-operation of robots. An example of compensating for time delays may be where the robot is located at a distant location from the user or operator such as tele-operating: on the moon, in a space station, in a mine, under the ocean, etc. A task may be sent to the robot to be accomplished. While a human's input might not be received in real-time, any changes a human may make can be applied to a 3D virtual model of the robot that is viewable by a user in real-time at the control location (e.g., here on earth or in an office).

Those user inputs and instructions may be sent to the distantly located physical robot to drive the remote robot to a desired state or task completion. Then the actual state of the robot as measured by internal and external sensors of the robot may also be applied to the virtual model of the robot after a delay time period (e.g., the time it takes to get the sensor data back from the remote location). This virtual model can account for and model all the physical dynamics in that physical environment. The sensors on the robot can measure disturbances and any additional forces, to allow the human to provide further input to the robot to successfully achieve the task in light of these additional inputs from the robot. This feedback loop provides latency accommodation while permitting the human to provide input to the feedback loop even though a delay is inserted into the user input or instructions.

The robot that is performing the task, whether locally or at a distance, may send back sufficient state information (e.g., robot state, environment state, error state, etc.) to update the virtual model of the robot (e.g., local virtual model or cloud virtual model) to which the user is providing instructions. Such feedback data may be especially important whenever an event is happening at the robot that constitutes an error condition or an unexpected event of some sort. Because the virtual model will be updated with the robot state, the user will effectively be seeing the state of the physical robot located at a distance from the user. The user input events, robot sensor events or other inputs may be time stamped and ordered appropriately to take into account the time delay of communications. Using time sequencing for the inputs or changes to the robot state can avoid conflicting instructions being applied to virtual model of the robot.

A virtual model of a robot can also be used for training of the artificial intelligence (AI) patterns that are used for autonomously operating the robot. For example, the patterns for walking, stepping and cadence can be collected by recording the movements of a human training the robot. The recorded movements of the human (e.g., exactly as recorded or as modified by developers and engineers) may be played back to operate the robot when the robot is in autonomous mode. This type of training may apply to any humanoid robot or other robot types that can be mapped to human movement, including robots that have: one arm, a torso, a hand, two arms, two legs, industrial lifting robots, digging robots, construction robots, robotic vehicles, etc.

In another example, the use of a virtual robot model can evaluate the efficacy of a physical system using an interface that uses the virtual robot model in a simulation environment. Using human input to control the virtual robot model can also be used to test whether the robot is capable of doing a task. This provides a way to illustrate the capability of the robot without using the physical robot or operation in a physical environment (e.g., lifting of bombs to mount them on a warplane). Using an accurate representation of the environment and robot, this type of simulation use allows the control system, robot, and user input to be developed and tested even without the physical robot.

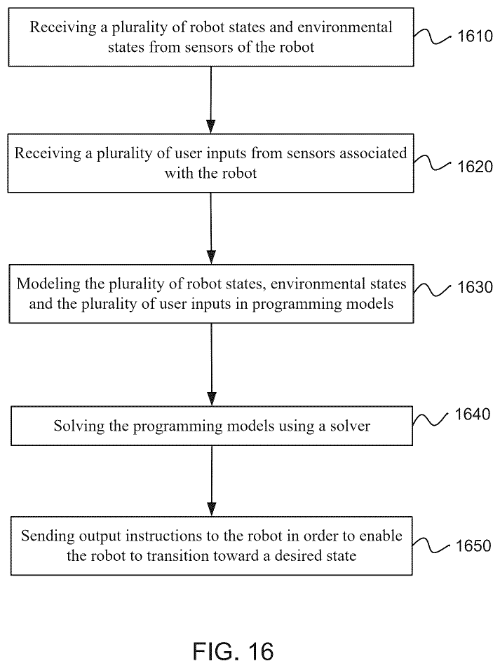

FIG. 16 is a flowchart illustrating a method for controlling a robot with hybrid control. One operation may be receiving a plurality of robot states and environmental states from sensors of the robot, as in block 1610. For example, a plurality of user inputs may be received from sensors of the robot that capture user input from a user embedded in the robot. A plurality of user inputs may be received from sensors associated with the robot, as in block 1620. In one example, a plurality of physical tasks may be provided to the solver (e.g., a quadratic solver or hierarchical quadratic solver). The plurality of user inputs may be prioritized as higher priority as compared to completion of the plurality of physical tasks provided to the solver.

In another example, safety constraint tasks may be prioritized at a highest priority level and general constraints may be prioritized at a second highest priority level in the solver.

The plurality of robot states, environmental states and the plurality of user inputs may be modeled in programming models (e.g., quadratic programming models), as in block 1630. The programming models may be solved using a solver, as in block 1640. The solver may be at least one of: a quadratic solver, a hierarchical quadratic solver, a genetic learning solver, a reinforcement learning solver, ant colony optimization, simulated annealing solver or a machine learning solver. In addition, fault constraints may be processed using the solver to determine a probability of a fault occurring. A task may be executed that includes explicit estimation of contact forces and joint torques used for tasks executing on the robot. In one embodiment, the priorities for a plurality of tasks for the robot, the user inputs and the environmental states may be set hierarchically.

The output instructions may be sent to the robot in order to enable the robot to transition toward a desired state, as in block 1650. The output instructions may be sent to a joint level control service and to an actuator control service. The robot may be enabled to perform tasks while satisfying safety constraints generated using sensors that sense locations of a user's anatomy in the robot.

The robot may perform tasks autonomously when no user input is being received. For example, the robot may switch to an automated task with a defined physical task for the robot when no user input is received.

The robot may be distantly controlled. The plurality of user inputs may be received from sensors associated with the robot that are located at a distance from the robot. The robot may also perform tasks based on user input constraints generated from sensors sensing a user input from a user that is distant from the robot.

The robot or a robot virtual model may use input from a human to train the robot or robot virtual model. For instance, error between a desired task output and a measured task output for the robot may be measured. Error between the desired task output and measured task output for the robot may be minimized using output instructions to the robot.

The robot may include at least one of: a portion of a humanoid form, a humanoid torso, at least one humanoid arm, humanoid legs, a humanoid hand, an end effector, a robot with non-humanoid kinematics, a vehicle, an automobile, a truck, a tank, an airplane, a ship, or a flying drone.

The robot may also be used to perform a task of lifting of weights. A payload felt by a user may be minimized while lifting and carrying payloads based in part on a stage of transporting the payload.

Models will now be described for semi-autonomous functionality for an exoskeleton. The two tasks described are autonomous standing/balancing and walking.

### Standing and Balancing

Standing and balancing of the robots can be achieved using a controller. This controller may enforce task space constraints hierarchically via quadratic programming on a subset of the dynamics, which reduces the complexity of the control problem while allowing hybrid position/force control. Below is a brief overview of the process.

### Partial Force Control

The derivation of the partial force controller will be described now. This controller reformulates a constrained hierarchical optimization problem on the full set of dynamics into smaller independent problems by resolving which contact forces are necessary for floating base (FB) control and which can be explicitly controlled. These independent problems are more computationally efficient and the resulting process allows for control over both positions and some forces.

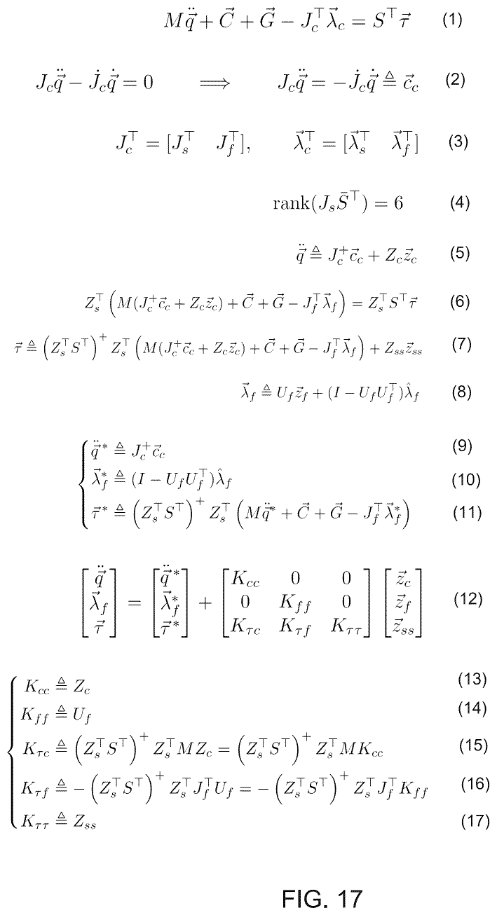

Consider the following floating base dynamics in Equation (1) in FIG. 17, where [symbol] ∈ [symbol] ⁿ⁺⁶ represents robot joint accelerations, M∈ [symbol] ^{(n+6)×(n+6)} is the mass matrix, and \vec{C}∈ [symbol] ⁿ⁺⁶ and \vec{G}∈ [symbol] ⁿ⁺⁶ are the velocity torques (i.e., Coriolis and centrifugal) and torques due to gravity, respectively, where n is the number of actuated DOFs. The Jacobian for all contacts is given by J_{c} ∈R^{k×(n+6)} and the contact wrenches are given by \vec{λ}_{c} ∈R^{k} (where k is the number of contact forces/moments). Lastly, the torques applied to each actuated DOF are represented by \vec{τ}∈Rⁿ while S=[0_{n×6} I_{n×n}] is a selection matrix such that S^{T}\vec{τ}=[0_{1×6} \vec{τ}^{T}]^{T}.

Assuming at this point that the robot is making contact with the ground with flat feet with no other contact points, it is reasonable to assume that those feet are to remain motionless while in contact with the ground (i.e., that “stick-slip” conditions are met). This can be expressed as an equality constraint in the joint configuration space as Equation (2) in FIG. 17 where \vec{ } c_{c} represents the acceleration constraint.

The contact Jacobian may represent all contacts that the robot makes with the world. For the FB to be controllable, the rank of this Jacobian transpose is 6 while the number of contact forces/torques may be larger than that. Therefore, any redundant contact forces, which do not affect FB control, are free to control. The contact wrenches can be broken up into those forces/torques to be controlled or free wrenches (\vec{λ}_{f}) and those that are necessary for supporting the FB or support wrenches (\vec{λ}ₛ). Then J_{c} can similarly be partitioned into the free and support Jacobians (J_{f} and Jₛ, respectively) as in Equation (3) of FIG. 17.

Now consider the floating base selector matrix S̅=[I_{6×6} 0_{6×n}]. A floating base system may be sufficiently constrained iff Equation (4) of FIG. 17 is true, i.e., rank (JₛS̅^{T})=6, which is to say that the supporting contact points are capable of controlling all 6 FB DOFs through the choice of \vec{λ}ₛ. This enables (a) control over the FB while (b) splitting the optimization problem into two separate smaller optimizations that consider the sufficient control of the FB in the presence of the free (controlled) wrenches.

In order to divide the full dynamics into simpler subsets, Equation (2) can be inverted to yield the following solution for [symbol] as in Equation (5), of FIG. 17, where Z_{c} represents the nullspace of J_{c} and \vec{z}_{c} is a free parameter. By substituting this value back into Equation (1) and multiplying by the transpose of the support Jacobian¹, this results in Equation (6) as in FIG. 17.

As the system is sufficiently constrained,

$${Z}_{s}^{T} {S}^{T}$$

has full row-rank, which means Equation (6) can be inverted resulting in Equation (7), where Zₛₛ represents the nullspace of

$${Z}_{s}^{⊤} {S}^{⊤}$$

and \vec{z}ₛₛ is anouier nee parameter. Lastly, because J_{f} might be rank deficient, the free wrench can be defined by the minimal representation of Equation (8) of FIG. 17, where U_{f} is the range of the free Jacobian J_{f}, \vec{z}_{f} is the free parameter that spans it, and \hat{λ}_{f} is a measurement of the free wrench (if available). This measurement will only be necessary if J_{f} is rank deficient, otherwise the matrix

$$( I - {U}_{f} {U}_{f}^{⊤} )$$

is empty.

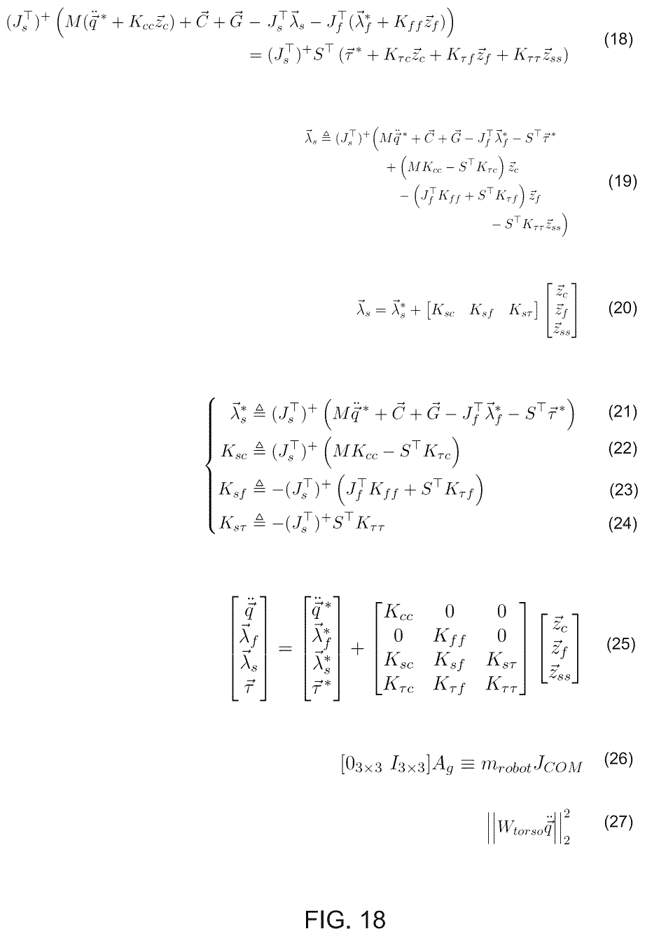

With the definitions of Equations (9), (10) and (11), Equations (5), (7), and (8) can be rewritten as Equation (12) in FIG. 17, where Equations (13), (14), (15), (16), and (17) result. To find the equation that relates these three free variables to the support wrench, Equation (12) can be substituted into Equation (1) and multiplied by the pseudoinverse of the support Jacobian transpose to create Equation (18) in FIG. 18, which then yields Equation (19).

Note that because the problem is sufficiently constrained, the nullspace of

$${J}_{s}^{⊤}$$

is the empty set, which means that the pseudoinverse of

$${J}_{s}^{⊤}$$

parameters. Therefore, if

$${}^{1} {Z}_{s}^{⊤} {J}_{s}^{⊤} = ∅$$

Equation (19) is re-written as Equation (20), where Equations (21)-(24) apply, the system of full equations can be rewritten as a function of free parameters as equation (25).

It is important to note that by Equation (25), joint accelerations and the free wrench(es) can be solved independently as they only depend on the free parameters \vec{z}_{c} and \vec{z}_{f}, respectively. This is the basis for the partial force control paradigm, where through the stick-slip conditions, we are able to formulate acceleration and force tasks that can be solved independently and at the same time (instead of having to invert the entire dynamics to solve for both simultaneously).

The resulting support wrench (\vec{λ}ₛ) and joint torques (\vec{τ}) can then be solved through an arbitrary choice of the last free parameter (\vec{z}ₛₛ) whenever

$${Z}_{s}^{⊤} {S}^{⊤}$$

has a nontrivial nullspace (e.g., during dual support). This last parameter will be discussed at length in the section on additional constraint optimization, where this parameter is derived to enforce some cost function on the foot wrenches during dual stance (e.g., minimum tangential forces/wrenches). The following section will discuss how these independent position and force tasks are defined (and solved) and how this last free variable is resolved.

### Hierarchical Task Space Optimization Constraints

In addition to formulating the control problem using the partial-force approach, prior systems can also solve tasks hierarchically. That is, each task priority level is solved and then any following tasks are solved in the nullspace of the higher priority task(s), ensuring that the addition of a new task does not violate previous tasks. This can be particularly useful when designing a balance controller as it can enforce that certain tasks will fail in favor of higher priority tasks (e.g., arm positions may deviate from desired so long as the desired COM/momentum needed for balance at a higher priority level is satisfied).

Locomotion has been accomplished by moving the COM (center of mass) over one foot (the plant foot) using the joint acceleration free variable while the wrench on the other foot (the swing foot) is driven to zero using the force control variable. As a lower priority acceleration task, the DOFs are then controlled via position control to be some nominal value. This ensures that any DOFs not used in the COM task will be controlled to return to some given posture. Once the COM is over the plant foot, a new joint acceleration task is placed in between the COM and the DOF position tasks to lift and move the swing foot (while removing the force task). Once the swing foot regains contact with the ground, the position control on the swing foot is removed and a new force task on the swing foot is issued that drives the force back up to an appropriate value (i.e., the weight of the robot). While this is happening, the COM is moved back towards the center of the contact polygon, at which point the algorithm is repeated by switching the plant and swing feet designations.

In past systems, the systems do not lay out how these tasks are defined. They may assume that the GRFs are being measured directly (as they use the normal force on the feet as weighting coefficients for the foot wrench optimization; see section below), so this technology can assume that for the task that drives the swing foot wrench to zero the previous systems directly close the loop on that measurement (presumably by a PD policy). Second, prior systems “regulate [the swing foot's] contact force to zero” before swing and then “slowly raise [it] from zero to an appropriate value (i.e., the weight of the robot)” once the swing foot regains contact with the ground. However, the way in which the value is driven to zero (linearly or with some spline) and the “appropriate level” for the normal force are relevant. Controlling the position of the DOFs at the lowest priority, along with the position/orientation of the floating base can be important. This may use a desired FB trajectory in addition to the desired COM trajectory. For the FB orientation, the present system can close on some desired FB orientation, but the FB position evolves with time based on the COM location.

This technology may use a set of tasks for Real-Time to address these issues above. First, instead of just controlling for the COM, this technology can control the centroidal momentum (or more specifically, momentum rate at the joint acceleration level) and attempt to minimize angular momentum. The centroidal momentum matrix (A_{g}) that relates joint velocities to the momentum of the COM as well as an acceleration task that closes the loop on some desired COM/momentum are derived later in this description. This is equivalent to controlling the COM explicitly through the COM's Jacobian (J_{COM}) as in Equation (26) in FIG. 18, where m_{robot} is the mass of the robot and the last three elements of momentum represent linear momentum.

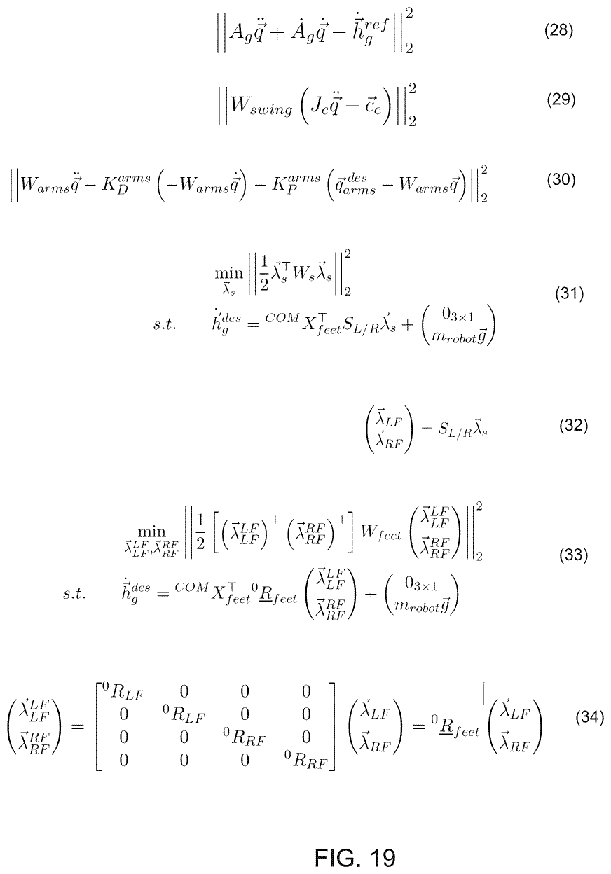

Next, this process does not explicitly control the swing foot's wrench with the force control free variable, opting instead to use the last free variable (\vec{z}ₛₛ) to enforce some optimal feet wrenches that are calculated a priori. This is because (1) measurements of feet wrenches are not available, so we cannot close the loop on the variable and (2) the “appropriate level” of foot wrench that should prescribe is not known in advance. A later section will discuss how the foot wrenches are “controlled”, but in short, the feet wrenches are solved that satisfy the desired rate of momentum while not violating the unilateral constraints of contact, weighted by some desired mass percent gravity fraction on each foot. Lastly, most acceleration tasks are kept at the same priority level. It is “most” because there is a dummy priority level at the top that removes the torso DOFs from subsequent tasks as local position controllers may be used to keep the torso DOFs rigid. This is mostly because the torque controllers for the torso DOFs are not very accurate and tend to become unstable (and because stepping work in a simulation without these DOFs). All the other tasks have the same priority level because (1) the problem is formulated as one quadprog problem (which allows exploring of inequality constraints) and (2) in most cases, solutions could be found that satisfy all constraints. It should be noted, however, that position control tasks are not enforced for all DOFs, instead opting to control the position of the arm DOFs only. This is why there have not been competing tasks in simulation that would use a nullspace optimization for solving. Specifically, the tasks are defined as,
Task 0: See Equation 27, in FIG. 18. where Wₜₒᵣₛₒ selects for the torso DOFs only.
Task 1:
   Momentum Control (See Section on Rate Centroidal Momentum Task): See Equation (28) in FIG. 19.
   Foot Position Task (when applicable):
   See Equation (29) in FIG. 19, where W_{swing} is a selector matrix that selects the swing foot (when swinging) and \vec{ }c_{c} is the foot contact acceleration task that has been modified to reflect the desired spatial acceleration of the swing foot, which includes some PD terms on the desired foot position and velocity.
   Arm DOF Position Task: See Equation 30 in FIG. 19, where Wₐᵣₘₛ selects for the arm DOFs only and

$${K}_{P}^{arms} and {K}_{D}^{arms}$$

are diagonal PD that close the loop on some desired arm pose with zero velocity.

### Additional Constraint Optimization During Dual Stance

During dual stance, control of the floating base is redundant. As such, there is a nontrivial nullspace to

$${Z}_{s}^{⊤} {S}^{⊤}$$

which allows enforcement or some additional constraint on the foot wrenches that satisfy the desired rate of momentum

$$( {}^{\dot{\to }} {h}_{g}^{des} ) .$$

Specifically, the optimization shown in Equation (31) of FIG. 19 can be solved, where Wₛ is some weighting matrix,

$$COM {X}_{feet}^{⊤}$$

the spatial transform that moves wrenches at the feet to the COM, and S_{L/R} is a selection matrix that takes the contact wrench and returns the vector of left/right feet wrenches (See Equation (32)).

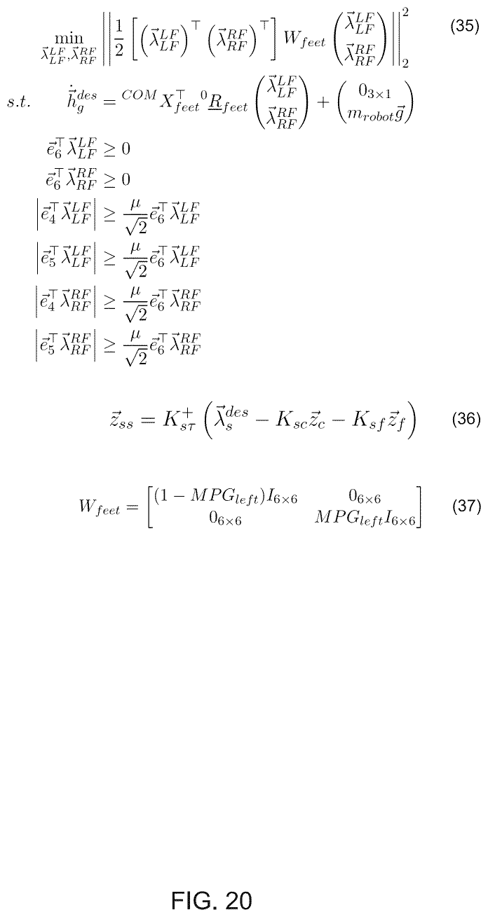

Some prior approaches have chosen to solve their optimization problem in the world frame, which is equivalent to solving in the foot frame (for symmetrical tangential moment/force weights) when flat ground is assumed. The optimization problem can be rephrased in the local foot frame to handle uneven terrain by (1) replacing \vec{λ}ₛ with Equation 32 and then (2) redefining the weight matrix to include a rotation from the world frame into the local foot frames. The optimization problem instead becomes the Equations (33) in FIG. 19 where W_{feet} is a diagonal weighting matrix in the local foot frame and ⁰R_{feet} is given by Equation (34) in FIG. 19. Another benefit of solving the optimization in the local foot frame is the possibility to address the unilateral and friction constraints in a more intuitive fashion (e.g., the normal force cannot be negative and the lateral forces must not violate a friction cone, approximated as a friction pyramid). Therefore, the full optimization problem may be given by Equation (35) in FIG. 20, where \vec{e}ᵢ is the i^{th} generator vector (e.g., \vec{e}₁=[1 0 0 0 0 0]^{T}) and u is some coefficient of friction.

The solution to this QP is then converted via Equations (32) and (34) to some desired support wrench

$$( {\vec{λ}}_{s}^{des} )$$

which is then ted into the controller. When there is a nontrivial nullspace of

$${Z}_{s}^{⊤} {S}^{⊤} ,$$

the value of \vec{z}ₛₛ that accomplishes these feet wrenches is solved for by inverting Equation (20) and using the optimal values of the other two free parameters. See Equation (36).

The choice of W_{feet} was traditionally chosen to (a) minimize tangential moments and forces (which helps to guarantee that the ZMP (zero moment point) stays inside the foot polygon during dual stance) while (b) penalizing the foot with smaller normal force magnitude so as to not use a foot that is actively being deweighted. As we do not have measurements of the feet normal forces, we instead chose to use the desired mass percent gravity (MPG) fraction to drive a given plant foot's weights to zero as we approach single support (thus ensuring that the optimal solution to the above QP will use the infinitely-less penalized plant foot wrench). Additionally, because of the nature of the robot's kinematics (specifically because the COM is generally not over the center of the foot plates during balance), minimizing tangential moments and forces resulted in larger tangential forces that were used to cancel out the moment at the COM caused by this offset. This would also cause some ringing in the optimal foot wrench solution that would cause the system to go unstable. Therefore, we found that the weight matrix can be defined as Equation (37) in FIG. 2, so that when the robot is over the left foot (MPG_{left}=1) the weights in the upper left block become zero and the optimization solves for left foot wrenches as the right foot wrenches are infinitely more penalized. In this way, as the COM moves towards single support, we naturally deweight the swing foot in a smooth continuous fashion given that our desired MPG signals are smooth and continuous. More importantly, when the COM moves back toward the center, the previous swing foot wrench values can be raised to some “appropriate level” as determined by the desired momentum rate equation.

### Centroidal Momentum Control

One possible implementation of auto-balancing on the robot may utilize a controller which resolves hierarchical control tasks as either position tasks or force tasks. The position task is formulated as a joint acceleration task by effectively enforcing the solutions to be found in the nullspace of the “slip-stick” acceleration constraint (no-acceleration at the feet s.t. J_{feet} [symbol] +J_{feet}\vec{q}=0). Therefore, controlling the robot's center of mass (COM) can be done by formulating a task on the rate of centroidal momentum. This description will now describe (a) the centroidal momentum matrix that relates joint velocities to the momentum of the COM, (b) the formulation of desired values for the centroidal momentum (as well as the COM's position and orientation), and (c) discuss how these values can be used together to create a stable control policy for momentum as an acceleration task.

### Centroidal Momentum Matrix

The centroidal momentum matrix (A_{g}∈R^{6×(n+6)}) relates the configuration velocities (\vec{q}∈Rⁿ⁺⁶) to the momentum of the center of mass or COM (\vec{ }h_{g} R⁶), where n is the number of actuated degrees of freedoms (DOFs), as in Equation (38). In the past, this matrix was calculated by finding the momentum of each individual link, which was then projected to the floating base (FB) and them summed before being projected to the COM To make this a joint acceleration task, the rate of centroidal momentum ( [symbol] _{g}) is often considered.

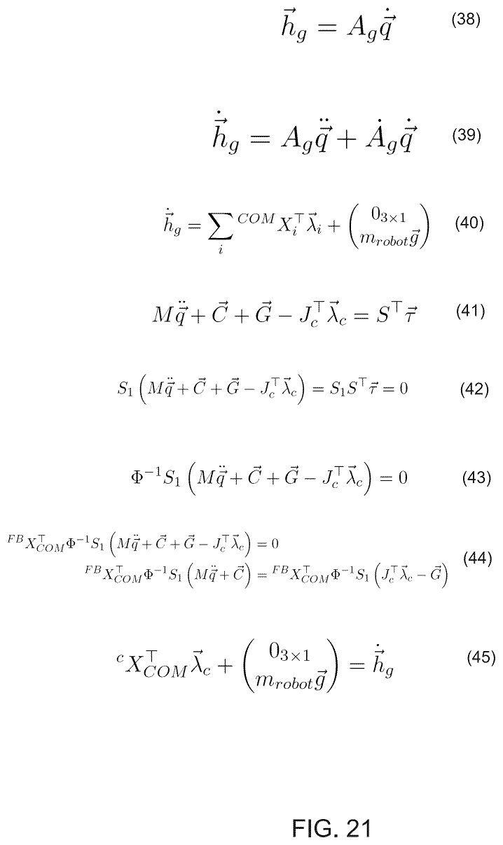

The calculation of A_{g}, while tedious in its link specific calculations, can be calculated in O(n), but techniques used to calculated A g are either explicitly calculating in O(n²) or in O(n) using finite difference methods (which can be prone to precision numeric issues). To improve upon these methods, the values of A_{g} as well as A_{g} \vec{q} can be derived by manipulating the floating base dynamics and projecting them to the COM. This approach is also able to recover the centroidal momentum rate equation as derived from Newton's second law where the sum of all external forces acting on the robot must be equal to the rate of (centroidal) momentum. See Equation 40, in FIG. 21 where λᵢ represents an external wrench applied to the robot, ^{COM}Xᵢ represents a spatial transform for the i^{th} frame to the COM (in the world frame), m_{robot} is the mass of the robot, and \vec{g}=[0 0-9.81]^{T} is the gravity vector.

In order to derive the above equations, consider the equations of motion in Equation (41), in FIG. 21 where [symbol] represents robot joint accelerations, M is the mass matrix, and \vec{C} and \vec{G} are the velocity torques (i.e., Coriolis and centrifugal) and torques due to gravity, respectively. The Jacobian for all contacts is given by J_{c} and the contact wrenches are given by \vec{λ}_{c}. Lastly, the torques applied to each actuated DOF is represented by \vec{τ}∈Rⁿ while S=[0_{n×6} I_{n×n}] is a selection matrix such that S^{T}\vec{τ}=[0_{1×6} \vec{τ}^{T}]^{T}. Consider a selection matrix S₁=[I_{6×6} 0_{6×n}] such that multiplying Equation (41) by S₁ selects for the FB dynamics only.

As the FB DOFs have been defined as 6 independent DOFs (3 linear & 3 rotational), Equation (42) in FIG. 21 represents the FB dynamics in the space of generalized FB forces and torques (which do not by definition represent a wrench). In order to convert this equation to one that operates in the FB wrench space, we rely on the principle of virtual work to define the relationship between generalized forces and the wrench at a point. Specifically, a matrix

$$Φ = {J}_{FB}^{⊤}$$

may be defined (which represents the first six rows of J^{T}) such that Equation (43) represents the floating base dynamics in its wrench space.

Now that Equation (43) represents a wrench space, we can move it from the FB to the COM by means of a spatial transform (^{FB}X^{T}_{COM}) as in Equations (44a) and (44b). Note that the first term on the right hand side of Equation (44b) represents the contact (external) forces on the system which have been applied to the FB and then moved to the COM. Additionally, the second term represents the gravity wrench experienced by the COM. As this represents the sum of all forces at the COM, we find that this has recovered the momentum rate equation given by Newton's second law (Equation (40)), which we can rewrite as Equation (45) in FIG. 21, where C

$${X}_{COM}^{⊤}$$

represents a horizontal concatenation of the spatial transforms from all contact points to the COM. This also implies that the left hand side of Equation (44b) represents the equation for rate of centroidal momentum, which is rewritten as Equations (46a) and (46b) as defined in light of Equations 47 and 48. Therefore, we are able to derive through the floating base equations of motion (a) values for both the centroidal momentum matrix and the effect of joint velocities on the rate of momentum and (b) the equations that relate (external) contact forces to the rate of momentum.

In order to control the momentum/COM using the approach derived from prior approaches we must formulate a linear acceleration task. For the sake of simplicity, assume that the control input was the joint acceleration ( [symbol] ). Then for some reference centroidal momentum rate

$$( {\dot{\vec{h}}}_{g}^{ref} ) ,$$

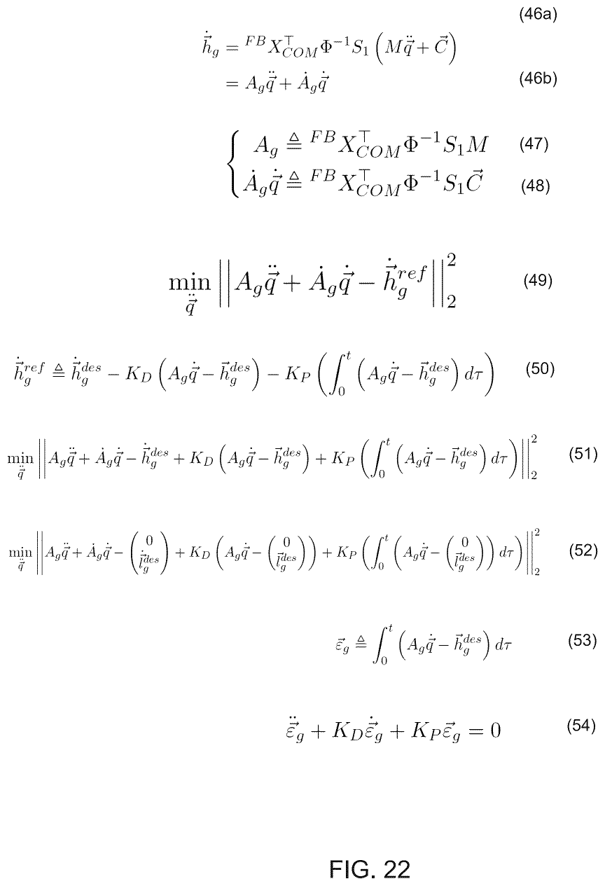

the following equality task/constraint can be defined to be minimize as defined by Equation (49) in FIG. 22. In order to ensure stable tracking of some desired centroidal momentum (\vec{h}^{des}), the reference momentum rate can be defined as in Equation (50) of FIG. 22 where K_{P} and K_{D} are traditionally chosen as positive definite, diagonal matrices. Equation (49) can then be rewritten as Equation 51.

It should be noted that the desired angular momentum (and momentum rate) are zero. Therefore, under that assumption, Equation (51) becomes Equation (52). If we define the momentum integral error (\vec{ε}_{g}) such that Equation 53 results, then Equation (51) becomes equivalent to finding the values of [symbol] that produce the equivalent second order system as in Equation (54), which is asymptotically stable with the proper choice of K_{P} and K_{D}. Other information about the semi-autonomous functionality for the subject robot(s) is described in the paper entitled “Moving past point-contacts: Extending the ALIP model to humanoids with non-trivial feet using hierarchical, full-body momentum control” by Parades, et al, which is incorporated by reference herein for all that the paper teaches and discloses.

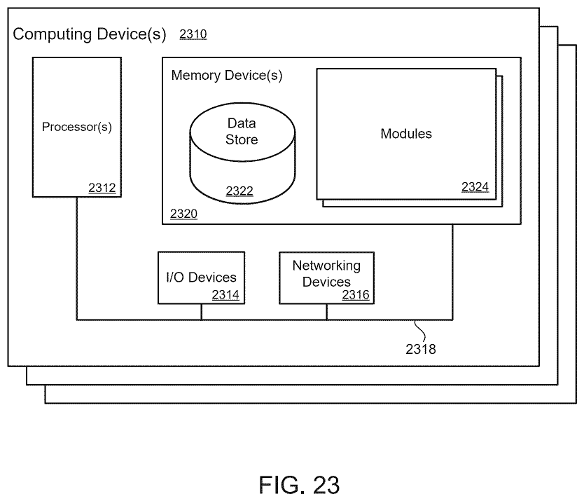

FIG. 23 illustrates a computing device 2310 on which modules of this technology may execute. The computing device 2310 is illustrated on which a high level example of the technology may be executed. The computing device 2310 may include one or more processors 2312 that are in communication with memory devices 2320. The computing device may include a local communication interface 2318 for the components in the computing device. For example, the local communication interface may be a local data bus and/or any related address or control busses as may be desired.

The memory device 2320 may contain modules 2324 that are executable by the processor(s) 2312 and data for the modules 2324. The modules 2324 may execute the functions described earlier. A data store 2322 may also be located in the memory device 2320 for storing data related to the modules 2324 and other applications along with an operating system that is executable by the processor(s) 2312.

Other applications may also be stored in the memory device 2320 and may be executable by the processor(s) 2312. Components or modules discussed in this description that may be implemented in the form of software using high programming level languages that are compiled, interpreted or executed using a hybrid of the methods.

The computing device may also have access to I/O (input/output) devices 2314 that are usable by the computing devices. An example of an I/O device is a display screen that is available to display output from the computing devices. Other known I/O device may be used with the computing device as desired. Networking devices 2316 and similar communication devices may be included in the computing device. The networking devices 2316 may be wired or wireless networking devices that connect to the internet, a LAN, WAN, or other computing network.

The components or modules that are shown as being stored in the memory device 2320 may be executed by the processor 2312. The term “executable” may mean a program file that is in a form that may be executed by a processor 2312. For example, a program in a higher level language may be compiled into machine code in a format that may be loaded into a random access portion of the memory device 2320 and executed by the processor 2312, or source code may be loaded by another executable program and interpreted to generate instructions in a random access portion of the memory to be executed by a processor. The executable program may be stored in any portion or component of the memory device 2320. For example, the memory device 2320 may be random access memory (RAM), read only memory (ROM), flash memory, a solid state drive, memory card, a hard drive, optical disk, floppy disk, magnetic tape, or any other memory components.

The processor 2312 may represent multiple processors and the memory 2320 may represent multiple memory units that operate in parallel to the processing circuits. This may provide parallel processing channels for the processes and data in the system. The local interface 2318 may be used as a network to facilitate communication between any of the multiple processors and multiple memories. The local interface 2318 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for controlling a robot with hybrid control, comprising:
receiving a plurality of robot states and environmental states from sensors of the robot;
receiving a plurality of user inputs from sensors associated with the robot;
modeling the plurality of robot states, environmental states and the plurality of user inputs in programming models;
solving the programming models using a solver; and
sending output instructions to the robot in order to enable the robot to transition toward a desired state.

2. The method as in claim 1, wherein the solver is at least one of: a quadratic solver, a hierarchical quadratic solver, a genetic learning solver, a reinforcement learning solver, ant colony optimization, simulated annealing solver or machine learning solver.

3. The method as in claim 1, wherein the programming models include inequality constraints.

4. The method as in claim 1, further comprising receiving the plurality of user inputs from sensors of the robot that capture user input from a user embedded in the robot.

5. The method as in claim 1 further comprising identifying a plurality of physical tasks provided to the solver.

6. The method as in claim 5, further comprising prioritizing the plurality of user inputs as higher priority as compared to completion of the plurality of physical tasks provided to the solver.

7. The method as in claim 1, further comprising prioritizing safety constraint tasks at a highest priority level and general constraints at a second highest priority level in the solver.

8. The method as in claim 7, further comprising enabling the robot to perform tasks while satisfying safety constraints generated using sensors that sense locations of a user's anatomy in the robot.

9. The method as in claim 1, further comprising enabling the robot to perform tasks autonomously when no user input is being received.

10. The method as in claim 9, further comprising switching to an automated task with a defined physical task for the robot when no user input is received.

11. The method as in claim 1, further comprising receiving the plurality of user inputs from sensors associated with the robot that are located at a distance from the robot.

12. The method as in claim 11, further comprising enabling the robot to perform tasks based on user input constraints generated from sensors sensing a user input from a user that is distant from the robot.

13. The method as in claim 1, wherein the robot may be at least one of: a portion of a humanoid form, a humanoid torso, at least one humanoid arm, humanoid legs, a humanoid hand, an end effector, a robot with non-humanoid kinematics, a vehicle, an automobile, a truck, a tank, an airplane, a ship, or a flying drone.

14. The method as in claim 1, wherein the robot or a robot virtual model uses input from a human to train the robot or robot virtual model.

15. The method as in claim 1, further comprising:
measuring error between a desired task output and a measured task output for the robot; and
minimizing error between the desired task output and measured task output for the robot using output instructions to the robot.

16. The method as in claim 1, further comprising sending the output instructions to a joint level control service and to an actuator control service.

17. The method as in claim 1, further comprising executing a task that includes explicit estimation of contact forces and joint torques used for tasks executing on the robot.

18. The method as in claim 1, further comprising minimizing a payload felt by a user while lifting and carrying payloads based in part on a stage of transporting the payload.

19. The method as in claim 1, further comprises processing fault constraints using the solver to determine a probability of a fault occurring.

20. A method for controlling a robot with hybrid control, comprising:
receiving a plurality of robot states and environmental states from sensors in the robot;
receiving a plurality of user inputs from sensors associated with the robot;
setting priorities for a plurality of tasks for the robot, the user inputs and the environmental states;
solving the plurality of tasks in a priority order using a solver; and
sending output instructions to the robot in order to enable the robot to move toward a desired state.

21. The method as in claim 20, further comprising prioritizing the plurality of tasks that include least one of: a balance task, a walking task, avoidance of self-collision, a safety task, a human input task, a communication delay task, a motion task, a lifting task, a placement task, a reorientation task, an adjustment task, a manipulation task, an arrival at a location at a defined time task, a task limiting acceleration or motion, or a task limiting speed.

22. The method as in claim 20, further comprising controlling the robot from a distance using user input obtained from remote sensors a distance from the robot.

23. The method as in claim 20, further comprising enabling dynamically consistent control of the robot while accounting for delays for an operator's instructions.

24. The method as in claim 20, further comprising providing self-collision avoidance using the solver.

25. The method as in claim 20, wherein the robot may be at least one of: a portion of a humanoid form, a humanoid torso, at least one humanoid arm, humanoid legs, a humanoid hand, an end effector, a robot with non-humanoid kinematics, a vehicle, an automobile, a truck, a tank, an airplane, a ship, or a flying drone.

26. The method as in claim 20, further comprising:
measuring an error between desired task output and measured task output for the robot; and
minimizing the error between the desired task output and measured task output for the robot using output instructions to the robot.

27. A method for controlling a hybrid robot that is distant from a controller, comprising:
receiving a plurality of robot states from sensors in a robot;
defining a virtual model of the robot based on the robot states;
receiving a plurality of user inputs from sensors associated with the robot;
prioritizing a plurality of tasks for the robot;
solving the plurality of tasks in a priority order using a solver in the controller,
wherein the plurality of user inputs is a constraint on the plurality of tasks; and
modifying the virtual model of the robot using output from the solver, while maintaining consistent control of the robot and accounting for delays in the plurality of user inputs.

28. The method as in claim 27, further comprising receiving state data from the robot to update the virtual model of the robot.

29. The method as in claim 27, further comprising sending output instructions to the robot located at a distance from a user in order to enable the robot to transition toward a desired state.

30. The method as in claim 27, wherein the plurality of user inputs is from sensors that are distant from the robot.

31. The method as in claim 27, further comprising enabling at least partial control of the virtual model of the robot to facilitate control of the virtual model of a robot or a real robot both with and without time delays.

32. A system to control a robot that is distant from a controller, comprising,
at least one processor;
a memory device including instructions that, when executed by the at least one processor, cause the system to:
receive a virtual model of a robot having robotic states and simulated environment in which the virtual model may virtually operate;
receive a plurality of user inputs from sensors associated with the virtual model of the robot;
set the robotic states of the virtual model based in part on the user inputs;
prioritize a plurality of tasks for the robot;
solve the plurality of tasks in a priority order using a solver in the controller, wherein the user inputs are a constraint on the plurality of tasks; and
modify a virtual model of the robot using output from the solver enabling a user to rehearse a task in a simulated environment.

33. The system as in claim 32, further comprising determining whether a task is possible using the virtual model of the robot.

34. The system as in claim 32, further comprising recording a user completing a task numerous times to establish an expected range of operation for a task versus operations in during the task that might qualify as an error condition.

35. The method as in claim 32, further comprising sending output instructions to the robot located at a distance from a user in order to enable the robot to transition toward a desired state.

36. The method as in claim 32, further comprising receiving sensor feedback from the robot located at a distance from a user in order to enable the robot to modify a virtual model of the robot.
